(19) United States
(12) Patent Application Publication
(10) Pub. No.: US 2003/0067120 A1
(43) Pub. Date: Apr. 10, 2003

(54) Reciprocating shaft seal

(76) Inventor: Richard James Armstrong, Toronto (CA)

Correspondence Address: Richard James Armstrong, Apt. 703, 7 Jackes Ave., Toronto, ON, M4T 1E3, CA

(21) Appl. No.: 09/971,140

(22) Filed: Oct. 5, 2001

(51) Int. Cl. F16J 15/20

(52) U.S. Cl. 277/534

(57) ABSTRACT

A rubber bellows type seal (23) for reciprocating motion having an improved stroke to length ratio is obtained by fully separating the annular rubber convolutions (30) by axial deflection spaces (31,32) to allow the convolutions to be freely deflected in both directions This double deflection gives the bellows an increased stroke and thus an increased stroke to length ratio. Inner and outer tubular elements (25, 28) are bonded to the convolutions to support them in spaced apart working relationship.

### FIELD OF THE INVENTION

This invention relates to improvements in positive acting pressure seals of the bellows type employed for sealing reciprocating shafts and the like.

### BACKGROUND

It has been common practice in the prior art to form a positive acting reciprocating seal by means of multiple cone shaped flexing elements alternately joined at the inner and outer edges. This is the common bellows construction of the prior art, illustrated generally as 11 in FIG. 1.

The bellows 11 has an overall cylindrical configuration and is built up from cone shaped flexing elements 12 made from rubber which are alternately joined at the inner and outer apices as at 13 and 14 respectively. In this case the flexing elements 12 have a thick cross section to withstand a moderate pressure difference when used as a shaft seal. Flexing elements 12 are separated by triangular spaces 15 and 16 to provide axial deflection space for flexing elements 12 upon bellows 11 being compressed.

Positive sealing is effected by having the ends of the seal provided with attachment flanges 17 for securing one end to a fixed part or structure (not shown) while the other end is attached to a reciprocating part or shaft (not shown). The stroke of the seal is achieved by the combined deflection of the flexing elements 12 into the triangular spaces 15 and 16 and a selected number of flexing elements are employed to give the required stroke.

The ratio, stroke length to overall seal length, which I define as the stroke ratio, of a reciprocating seal is an important consideration in applications where mounting space is at a premium. It is advantageous to have a comparatively large stroke ratio because less space is then occupied by the seal for the required stroke.

The prior art bellows seal shown in FIG. 1 may be made for either a compression stroke or for an extension stroke but generally not both in one seal. If the flexing elements 12 are positioned close together and spaces 15 and 16 are very narrow, compression is prohibited and the seal must be operated in extension only.

If the flexing elements are angled far apart as illustrated in FIG. 1, further extension will unduly strain the joint between the flexible elements, and the seal must be operated in compression only. This limits the stroke ratio of prior art seals to that obtained by deflection of the flexible elements in one direction only.

It would be possible to mold the flexing elements in an intermediate position and the bellows may then be operated in extension and compression but this approach adds nothing to the overall obtainable stroke and thus would not increase the stroke ratio.

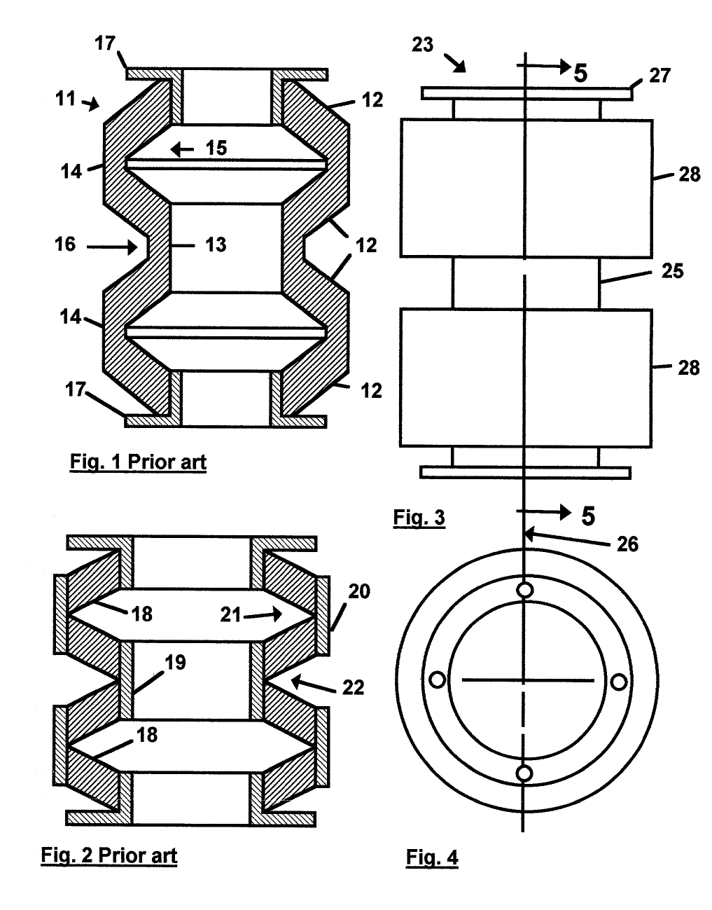

Another type of prior art bellows is illustrated in FIG. 2. This type is disclosed in U.S. Pat. No. 6,237,922 B1. The flexing elements 18 are of the rubber shear type and are bonded to inner metal hoops 19 and outer metal hoops 20.

This bellows also employs the common cone shaped flexing elements and has the same limited stroke ratio as discussed for the type shown in FIG. 1. Here again triangular shaped deflection spaces 21 and 22 are provided which allow axial displacement of flexing elements 18 in compression only. This single direction of displacement also limits the obtainable stroke ratio for this type of bellows. The alternate joining of flexing elements 12 as at 13 and 14, or flexing elements 18 as at 19 and 20, is the construction which limits the stroke of the elements and thus limits the stroke ratio. This method of joining together the flexing elements is universal in application in the prior art.

The Invention:

I have found that by providing my flexing elements as flat annular shear rings that are fully separated by axial deflection spaces, they can be deflected in both directions and my seal may thus be flexed in both compression and extension to give a larger stroke ratio than can be obtained by the method of the prior art. This enables a shorter seal to be employed for a given stroke. Inner and outer tubular elements are provided to support my flexing elements in working relationship as more fully explained hereinafter.

In the Drawings:

FIG. 1 is a diametrical section of a prior art bellows type seal;

FIG. 2 is a diametrical section of another type of prior art bellows seal;

FIG. 3 is a side view of a preferred form of my seal;

FIG. 4 is an end view of the seal shown in FIG. 3;

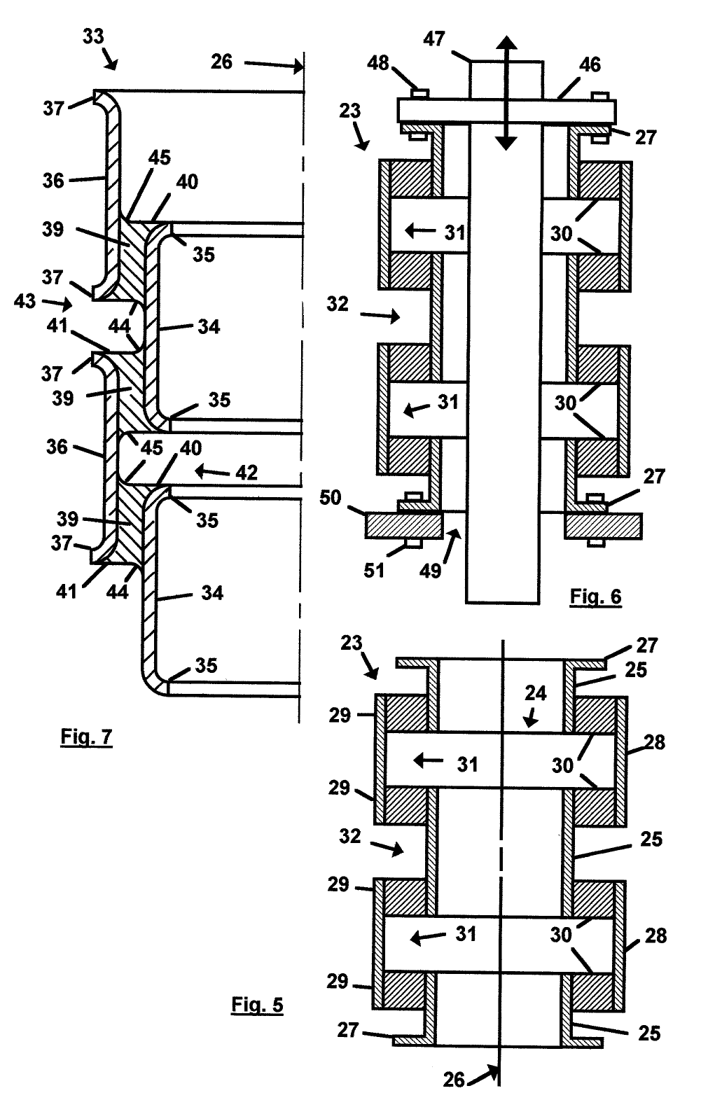

FIG. 5 is a diametrical section along the line 5-5 in FIG. 3,

FIG. 6 is a diametrical sectional view of a typical application of my seal;

FIG. 7 is an enlarged radial section of another preferred form of my seal;

FIG. 8 is a diametrical sectional view of my seal as assembled;

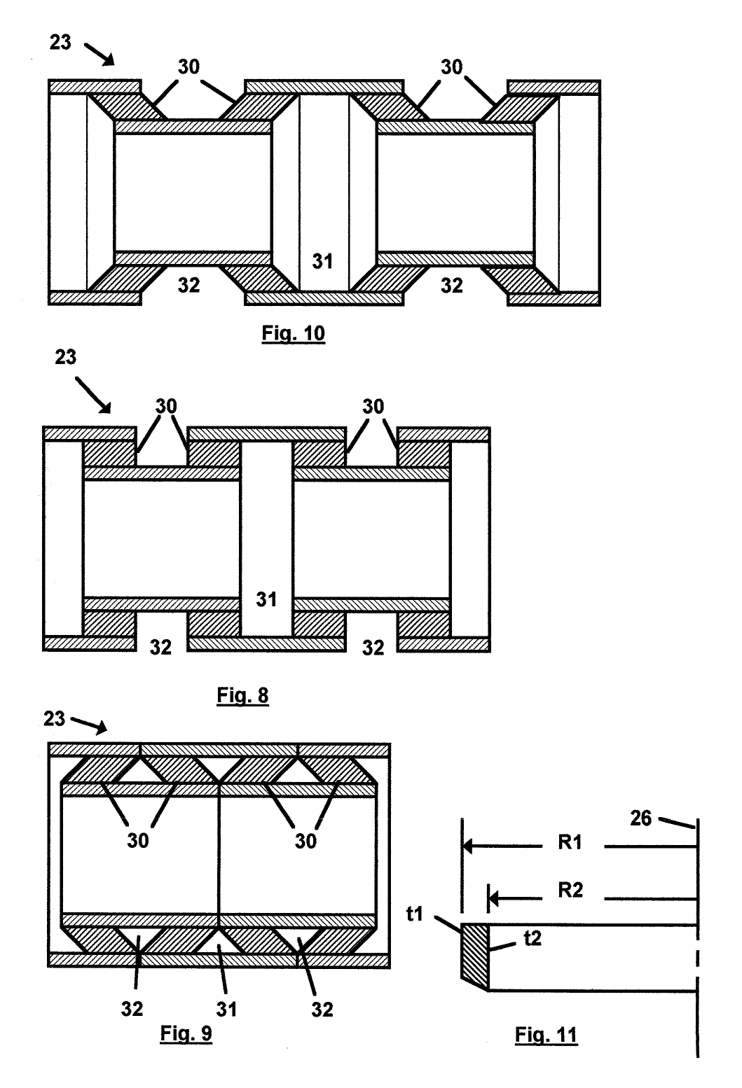

FIG. 9 is a diametrical sectional view of the seal in FIG. 8 shown fully compressed;

FIG. 10 is a diametrical sectional view of the seal in FIG. 8 shown fully extended; and,

FIG. 11 is a radial section through a shear ring according to the present invention.

### DETAILED DESCRIPTION OF THE PREFERRED EMBODIMENT OF THE INVENTION

With reference to FIG. 3, FIG. 4 and FIG. 5 my seal, indicated generally as 23 is of an overall cylindrical form and has a central bore 24 as shown in FIG. 5 through which a reciprocating shaft (not shown) may pass. Seal 23 has inner tubes 25 axially and concentrically spaced apart along a common axis of symmetry 26. Inner tubes 25 have a predetermined diameter according to the size of the seal required to accommodate the reciprocating shaft. Alternatively inner tubes 25 may have a diameter to fit about an opening through which a shaft operates.

The ends of the terminating inner tubes 25 may be provided with flanges 27 for attaching one end of seal 23 to a reciprocating shaft and the other to fixed structure. Other attachment configurations for the terminating inner tubes 25 as may be required for an application may also be employed. Seal 23 also has outer tubes 28 axially and concentrically spaced apart along axis 26 in positions intermediate between inner tubes 25 and with ends 29 overlapping the ends of inner tubes 25 as shown in FIG. 5.

The flexing elements of my seal are rubber shear rings 30 bonded to inner tubes 25 and to outer tubes 28 between the overlapping ends 29. Shear rings 30 are fully separated axially by annularly shaped inner deflection spaces 31 and annularly shaped outer deflection spaces 32 to provide for deflection of rings 30 in compression of seal 23. The spacing of tubes 25 and 28 should be normally equal but may be uneven in special circumstances where a variation in deflection of rings 30 is desirable to obtain a variable spring rate or travel for the seal 23.

Shear rings 30 are formed as flat annular rings as shown in FIG. 5 and can thus be fully flexed in extension as well compression since the flat configuration of rings 30 results in equal stressing in both directions of axial shear. The double deflection of rings 30 gives a greater stroke for the axial space they take up and thus gives a greater deflection ratio for my seal than would be possible with deflection in one direction only as practiced in the prior art.

I have thus discovered that by spacing the flexible elements farther apart a considerable improvement in the stroke ratio can be obtained. The increased stroke ratio thereby enables a shorter seal to be employed for a given stroke.

A general proof of this advantage gained by my invention is as follows.

Proof of Concept:

The overall length of any prior art bellows type of seal is composed of the total axial width FS occupied by the flexing members of any given configuration plus the total axial deflection space DS provided. The prior art deflection ratio R then is, by definition, equal to the total deflection space divided by the overall length.

In symbols;

R=DS/(FS+DS)

In my seal the axial deflection space is doubled, therefore the deflection ratio RM of my seal becomes;

RM=2×DS/(FS+2×DS)

or RM=DS/(FS/2+DS)

but DS/(FS/2+DS)>DS/(FS+DS)

therefore; RM>R

Thus the deflection ratio of a seal according to my invention is larger than that obtainable by reference to the prior art. This is a completely general proof and is valid for flexing elements of any comparative shape or size.

The proof is also valid for the bendable flexing elements commonly used in light duty prior art bellows which are employed as dust and moisture shields. Using my invention, the bendable flexing elements can be held spaced apart and secured to inner and outer supporting tubes. The flexing elements would thus be able to bend in both axial directions to give an improved stroke ratio. The above proof would still hold because it is independent of the type of flexing element used to construct the bellows, referring only to the axial width of the flexing elements, or in other words their thickness.

Shear rings 30, the flexing elements of my seal, can be made from the many commercially available elastomers; a selection being made with consideration being given to the operating environment to which the shear rings 30 are exposed. Professional practice should be followed in this selection. The name rubber as used herein is intended to mean any elastomer, whether a natural rubber compound, a synthetic rubber, or blends.

Deflection in my seal is obtained by a shearing action of the rubber rings 30 and not bending as commonly practiced in the prior art. The metal tubes 25 and 28, being bonded to the rubber rings 30, load them in shear during axial displacement of seal 23. I have found that the hardness of the rubber for rings 30 should be from 30 to 70 durometer Shore A scale. This gives a good spring back for the rubber during reciprocation of seal 23. An excellent reference for the design of rubber in shear is;

Handbook of Molded and Extruded Rubber 2nd edition 1959

The Goodyear Tire & Rubber Company, Akron Ohio USA.

The amount of overlap required between the ends of tubes 25 and 28 should be equal to the axial width of rings 30. The axial deflection spaces 31 and 32 have widths double the allowable shear displacement of rings 30 to allow a pair of adjacent rings to fully deflect inwardly upon compression of seal 23.

Tubes 25 and 28 are preferably made from metal or other comparatively stiff material to which the rubber shear rings 30 can be bonded. Stiffness of the material for tubes 25 and 28 is required to resist distortion when the rubber rings 30 are deflected in shear as seal 23 is compressed or extended. I have found that metal is admirably suited for this purpose because it provides an excellent bond surface for the rubber and can be made to have any required stiffness.

With reference to FIG. 7 an improved form of my seal is shown generally as 33 and wherein the inner tubes 34 are provided with inwardly bent flanges 35 and outer tubes 36 are provided with outwardly bent flanges 37. Rubber shear rings 39, bonded to tubes 34 and 36, have radially tapering lips 40 and 41 bonded to flanges 35 and 37 respectively. The function of tapering lips 40 and 41 is to reduce the unit loading on the rubber bond at the edges during shear displacement of rings 39 to guard against tearing away of the rubber from tubes 34 and 36. The radii of the bent flanges 35 and 37, and thus the size of lips 40 and 41, are preferably as large as possible commensurate with other design requirements.

The flanges 35 and 37 are preferably provided with a radius to which lips 40 and 41 are bonded but a chamfered edge may also be employed. The essential requirement is to provide for a reduced thickness of the rubber at the edge of rings 39 to reduce the unit load on the rubber to metal bond at the edges. A radiused flange is particularly suited for this requirement. Axial deflection spaces 42 and 43 having an annular configuration are provided and must be wide enough to allow fully a predetermined compression stroke of two adjacent rings 39 during compression of seal 33.

It will be seen that lips 40 and 41 are tapered in a radial direction and thus do not add to the axial length of rings 39. Since the overall length of seal 33 is determined by the axial length of rings 39 plus the deflection spaces 42 and 43, the formation of lips 40 and 41 in a radial direction obtains the desired reduced loading of the rubber bond at the edges without adding to the total axial length and so conserves the improved stroke ratio of my seal.

Tapering lips 44 and 45 are also provided where the rubber rings 39 meet the central portion of tubes 34 and 36 respectively. In this case the lips 44 and 45 are allowed to taper in an axial direction since in this position they do not add to the axial length of seal 33.

It will be understood that tubes 34 and 36 can be provided with radiused edges in place of bent flanges 35 and 37 and that flanging is only one way of forming a radiused surface for the bonding of the radially tapering lips 40 and 41 of rubber rings 39 thereto. Tubes 34 and 36 could also be machined from metal with the radii formed at the same time. As with the flanges 35 and 37, the preferred form is a radius and the size of the radii are preferably as large as possible for a given seal design.

The shear rings must be proportioned to take full advantage of the simple shear loading effected by the tubes 34 and 36. The inner and outer tubes define the inner and outer radius of the rings 30 and 39. The general dimensions of a shear ring are given in FIG. 11 where, with reference to the axis of symmetry 26;

Outer wall radius R1,

Inner wall radius R2,

Ring radial width Z=R1−R2,

Outer wall width=t1,

Inner wall width=t2,

Allowable axial shear displacement=d,

Deflection ratio B=d/Z.

There are preferred dimensionless relationships between the proportions of shear rings 30 or 39 and with reference to FIG. 11 these are:

The product radius times local shear ring axial thickness is constant so that R1×t1=R2×t2;

The ratio Q=Z/R1 defined as the spread ratio is preferably not greater than 0.3;

The ratio B=d/Z defined as the deflection ratio is preferably less than 2.0;

The ratio SS=(t1−d)/Z defined as the cant ratio should be not less than 1.

The shear ring in FIG. 11 is shown diagrammatically and without the tapering lips to better illustrate the overall dimensions of the ring although the lips would normally be employed.

The product radius times axial thickness determines the circumferential section area at any given radius from axis 26 and if the product is constant the area is constant. This gives equal unit loading throughout the shear ring during operation and avoids stress concentrations which could lead to undesirable bending strains.

Strictly followed the constancy of product would result in a curvature of the shear ring radial surfaces, however with the value of Q being less than 0.3 this curvature is very slight and can be ignored and a straight line between walls t1 and t2 substituted. However the equality of R1×t1=R2×t2 still applies.

The spread ratio is Q limited to not more than 0.3 because a large value for the spread ratio together with the constancy of the product radius times thickness can lead to inordinately large values for the inner wall width t2. I commonly employ a value between 0.2 and 0.3 for the spread ratio in design work.

The deflection ratio B determines the maximum shear strain and is limited to less than 2.0 because the higher values lead to high stress levels in the rubber, particularly at the edges, during operation of the seal. Since high stress tends to shorten service life, low values of d/Z are desirable. On the other hand with smaller values of B more elements in the seal are required to give a desired stroke. I commonly employ a value of 1.0 for the deflection ratio in design work with rubber hardness of 60 Shore A durometer and this gives acceptable values for bond stress due to deflection.

A minimum value for the cant ratio SS ensures a stable seal to prevent canting of the individual elements due to deflection under a pressure difference. The canting takes the form of the individual hoops canting at an angle to each other and can lead to unpredictable stress levels in the rubber. I find that a value of SS=>1.0 provides for a stable design.

I have also found that, using the proportions of the rubber ring as given herein and for a rubber hardness of 60 durometer Shore A, the number of rubber rings 30 in any one seal should not be greater than six rings. A larger number of rings can lead to buckling of the seal under pressure when it is operated in compression. If a longer stroke is required than can be obtained with six rings, larger diameter rings will be required which will give a greater deflection per ring and thus a longer stroke.

Operation of the Seal:

Referring to FIG. 6 a typical mounting of my seal is illustrated where one flange 27 is secured to a collar 46 on a reciprocating shaft 47 by fasteners 48 and the other flange 27 is secured about an opening 49 in a fixed structure 50 by fasteners 51. The shaft 47 is thus allowed to reciprocate freely through opening 49 while seal 23 maintains a positive pressure seal across the opening 49. Conventional means, such as gaskets or sealing compounds can be employed to seal flanges 27 to the respective attachments to make the joints pressure tight.

With reference to FIG. 8 the full stroke of seal 23 is obtained by the compression of shear rings 30 a predetermined amount into all spaces 31 and 32 as shown in FIG. 9 plus an extension of seal 23 by an equal amount as shown in FIG. 10. It will be seen from FIGS. 8, 9, and 10 that the annular shape of shear rings 30 and the annular deflection spaces 31 and 32 allow full deflection of shear rings 30 in both directions which results in the improved stroke ratio.

Since due to the flat annular shape there is no difference in the magnitude of rubber shear stress whichever axial direction my rings 30 are deflected, extension and compression of my seal may both be employed without unduly straining the rubber or the bond.

The same holds true for the improved form of seal shown in FIG. 7. The lips 40, 41 and 44, 45 reduce the stress on the rubber at the edges whichever direction rings 39 are deflected.

My invention thus provides a reciprocating seal having an improved stroke ratio and which may be advantageously employed in applications requiring a positive acting pressure seal where mounting space is at a premium.

I claim:

1. A reciprocating shaft seal characterized by:
Inner metal tubes axially spaced apart along a common axis;
Outer metal tubes axially spaced apart along said common axis in positions intermediate between said inner tubes;
Overlapping ends between said inner and said outer tubes;
Rubber shear rings having a flat annular configuration and bonded to said inner and said outer tubes between said overlapping ends; and,
Axial deflection spaces fully separating said rubber shear rings.

2. A reciprocating shaft seal characterized by:
Inner metal tubes axially spaced apart along a common axis;
Outer metal tubes axially spaced apart along said common axis in positions intermediate between said inner tubes;
Overlapping ends between said inner and said outer tubes;
Rubber shear rings having a flat annular configuration and bonded to said inner and said outer tubes between said overlapping ends;
Axial deflection spaces fully separating said rubber shear rings.
Outwardly facing radiused edges on said overlapping ends of said inner tubes;
Inwardly facing radiused edges on said overlapping ends of said outer tubes; and,
Radially tapered lips formed on said rubber rings and bonded to said outwardly and said inwardly facing radiused edges.
